(19) United States
(12) Patent Application Publication
(10) Pub. No.: US 2003/0079890 A1
(43) Pub. Date: May 1, 2003

(54) Method for extinguishing fire

(76) Inventor: Kenneth Britt, Ozark, AL (US)

Correspondence Address: Kenneth Britt, 110 Jeffrey Court, Ozark, AL, 36360, US

(21) Appl. No.: 10/253,011

(22) Filed: Nov. 25, 2002

Related U.S. Application Data
(60) Provisional application No. 60/325,132, filed on Sep. 26, 2001.

(51) Int. Cl. A62C 39/00

(52) U.S. Cl. 169/91

(57) ABSTRACT

Method of extinguishing fire: A vacuum is used to remove one of three elements from the burning flames. Fire cannot be maintained without fuel, heat and air. Combustible materials such as wood, paper, fabric, coal and flammable liquids—all of these substances require oxygen in order for them to burn. A vacuum is applied using maximum suction capability and simultaneously exhausting the oxygen and air from the burning flames.

Method of extinguishing fire: A vacuum is applied using maximum suction capability and simultaneously exhausting the oxygen and air from burning flames.

Vacuum:

1 torr=1/760 atmosphere

10=3 torr can be obtained using mechanic pump

10=3 torr can be obtained using diffusion pump+LN2 trap

1. What I claim as my invention is the method of extinguishing fire by exhausting the oxygen and air from burning flames by vacuum.
